(19) United States
(12) Patent Application Publication
(10) Pub. No.: US 2003/0052082 A1
(43) Pub. Date: Mar. 20, 2003

(54) Method of forming optical waveguides in a semiconductor substrate

(76) Inventors: Anisul Khan, Sunnyvale, CA (US); Ajay Kumar, Sunnyvale, CA (US); Sanjay Thekdi, Santa Clara, CA (US)

Correspondence Address: APPLIED MATERIALS, INC., 2881 SCOTT BLVD. M/S 2061, SANTA CLARA, CA, 95050, US

(21) Appl. No.: 09/957,395

(22) Filed: Sep. 19, 2001

(51) Int. Cl. G02B 6/12

(52) U.S. Cl. 216/24; 216/88; 216/39; 216/51

(57) ABSTRACT

Optical waveguides can be made accurately using conventional semiconductor processing and equipment by forming an opening in a suitable substrate, conformally depositing a first cladding layer in the opening, filling the opening with a core material, removing excess core material, as by chemical mechanical polishing, and depositing a second cladding layer thereover, said first and second cladding layers and said core material each having a different index of refraction. Such optical waveguides can be connected, horizontally and/or vertically, to other devices formed in or on the substrate.

This invention relates to a method of making optical waveguides using conventional semiconductor techniques. More particularly, this invention is directed to silicon-based optical waveguides and methods of making them in or on a silicon substrate using well established, semiconductor processes and equipment.

### BACKGROUND OF THE INVENTION

A method of making silicon-based waveguides is known comprising depositing a first or bottom cladding layer on a silicon substrate, depositing a layer of core material, such as silicon oxide, patterning and etching the core material to remove excess core material, and depositing a second or top cladding layer over the core material.

Such a waveguide is shown in FIG. 1 wherein a silicon substrate 1 has a first cladding layer 2 thereover. A thick core layer 6 is deposited over the first cladding layer, is masked, the mask patterned, and then the core layer 6 is etched to remove excess material so that only the guide core 6 remains. A second cladding layer 8 is deposited over the core layer. This waveguide method requires several deposition and mask and etch steps. In particular, the silicon oxide core material is a thick layer, e.g., about 15 microns thick. Because of the thickness of this layer, this layer on the silicon substrate is highly stressed. Further, when such a thick oxide layer is etched to form the core, the sidewalls become striated and rough. However, smooth sidewalls and upper surfaces of all of the layers of a waveguide is required for optical devices.

Thus it would be highly desirable to be able to form optical waveguides that do not have rough or striated surfaces that must be smoothed, increasing the cost of such devices.

### SUMMARY OF THE INVENTION

An optical waveguide is made in a suitable substrate using standard semiconductor techniques by first etching an opening in the substrate. A first cladding layer is deposited in the opening conformally, the opening is filled with a core material, the excess core material is removed as by chemical mechanical polishing, which provides a smooth surface, and a second cladding layer is deposited thereover. Any excess second cladding layer can also be removed by chemical mechanical polishing.

In a particular embodiment, a silicon substrate having layers of silicon oxide and silicon nitride thereon, is masked and etched to form a hard mask, and the silicon is etched to form an opening therein. A first cladding layer is deposited in the opening conformally and the opening is filled with core material. Excess core material and the silicon oxide layer are removed by chemical mechanical polishing, hereinafter CMP, which provides a smooth, polished surface, the silicon nitride layer is stripped away and a top or second cladding layer is deposited thereover.

### BRIEF DESCRIPTION OF THE DRAWING

FIG. 1 is a cross sectional view of a prior art waveguide.

FIGS. 2a to 2e illustrate the method steps used to make an optical waveguide in accordance with the invention.

FIGS. 3a to 3f illustrate the method steps used to make another embodiment of an optical waveguide in accordance with the invention.

FIGS. 4a to 4f illustrate the steps used to make still another embodiment of an optical waveguide in accordance with the invention.

FIGS. 5a to 5h illustrate the steps used to make a further embodiment of an optical waveguide in accordance with the invention.

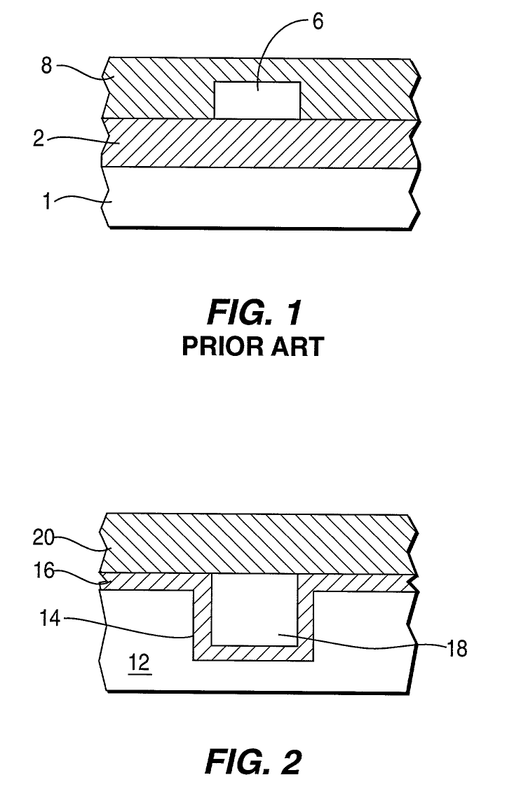

### DETAILED DESCRIPTION OF THE INVENTION

The present waveguides are readily made using standard semiconductor materials, processes and processing equipment. For example, the substrates can be of silicon, but other materials such as silicon-germanium, gallium arsenide, indium gallium arsenide, indium phosphide and the like can also be used. What is important in forming a waveguide is that the cladding layers and the core layer each have a different refractive index.

The present fabrication methods will be described using silicon or a silicon-containing material as the substrate, such as glasses that can be differently doped. The two cladding layers and the core material can be differently doped silicon oxides, so that the refractive index of each of these layers is different. Thus the cladding and core layers can be made of differently doped silicon oxide, such as glass, PSG, BPSG, quartz and the like.

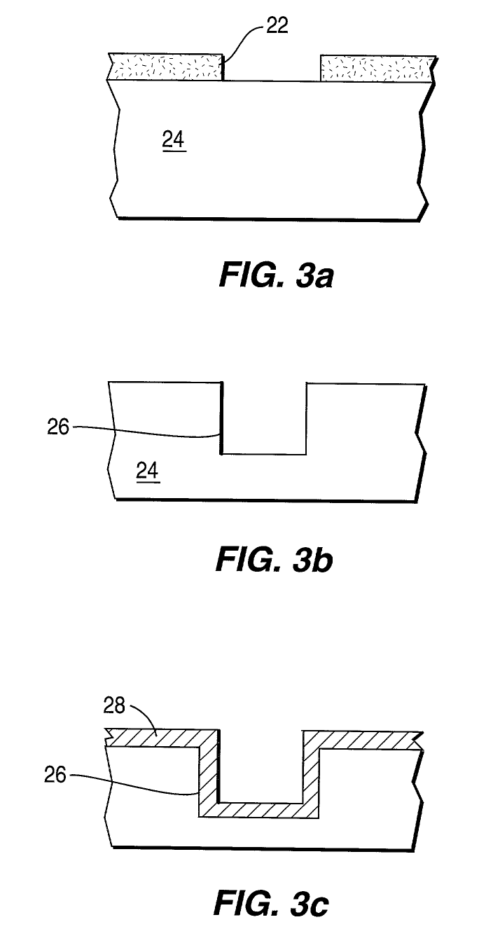

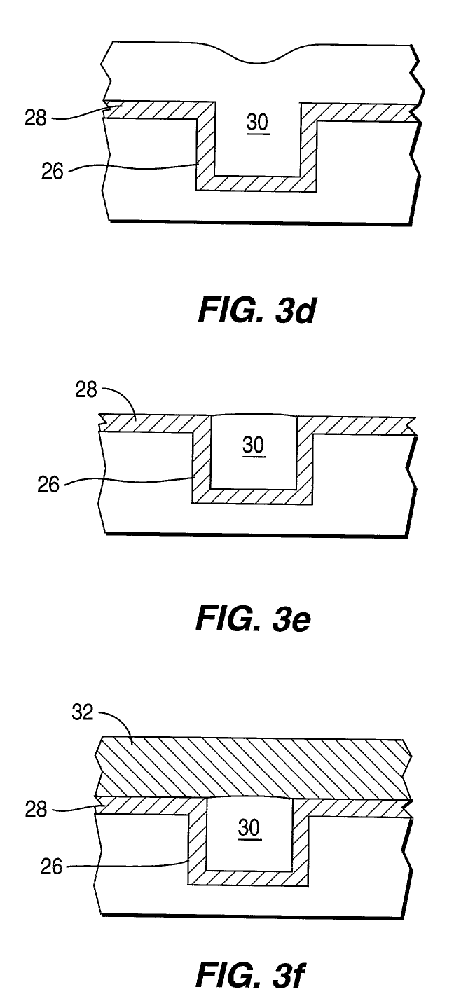

FIG. 2 illustrates a first silicon-based waveguide of the invention and method for making. The waveguide comprises a silicon-containing substrate 12, an anisotropic opening 14 etched into the substrate 12, a first or bottom cladding layer 16 deposited in the opening, which is then filled with a core material 18. The core layer 18 is planarized, such as by using chemical mechanical polishing, hereinafter CMP. This step eliminates the need for etching a thick core layer, and the present core layer remains smooth and polished. A second or top cladding layer 20 is deposited over the polished core layer 18. The steps for making a silicon-based waveguide are shown in more detail in FIGS. 3a to 3f.

A mask layer 22 is deposited over a silicon substrate 24 and patterned as shown in FIG. 3a.

An opening 26 is etched into the substrate 24 and the mask layer 22 removed, as shown in FIG. 3b.

A first or bottom cladding layer 28 is conformally deposited in the opening 26, as shown in FIG. 3c. The core material 30 is then deposited to fill the opening 26, as shown in FIG. 3d. The core material 30 can be silicon oxide that is doped so as to have a different index of refraction than silicon or the first cladding layer. As shown in FIG. 3e, the core material 30 is then planarized, as by CMP.

As shown in FIG. 3f, a top cladding layer 32 is then deposited over the planarized core layer 30. This top cladding layer 32 can also be a silicon oxide, but one that is differently doped to have a third refractive index.

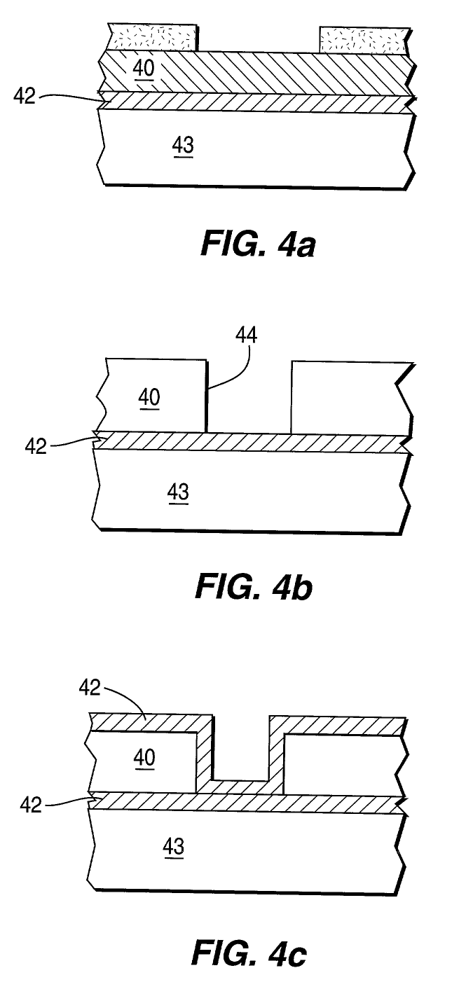

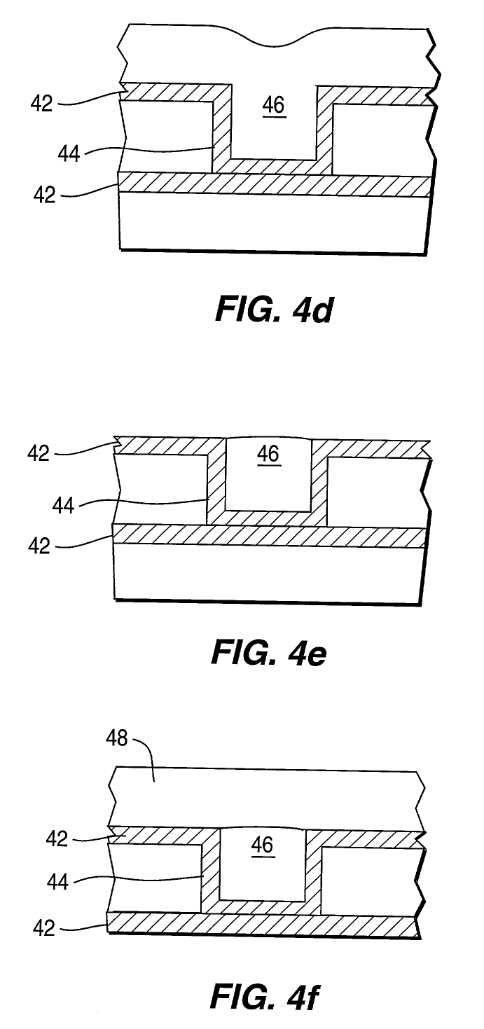

In another embodiment of the present invention, as shown in FIG. 4a, the substrate can be silicon on insulator (SOI), such as a silicon layer 40 on two silicon oxide or glass layers 42 and 43, each having a different refractive index.

The silicon layer 40 is masked and etched to form an opening 44 through the silicon layer 40 down to the first glass layer 42, which becomes the first or bottom cladding layer, as shown in FIG. 4b. An additional layer 42 of glass can be deposited conformally in the opening over the first glass layer 42, as shown in FIG. 4c. A core material 46 is then deposited to fill the opening, as shown in FIG. 4d.

The core layer 46 is then planarized, as by CMP, as shown in FIG. 4e. A second or top cladding layer 48 is then deposited thereover, as shown in FIG. 4f.

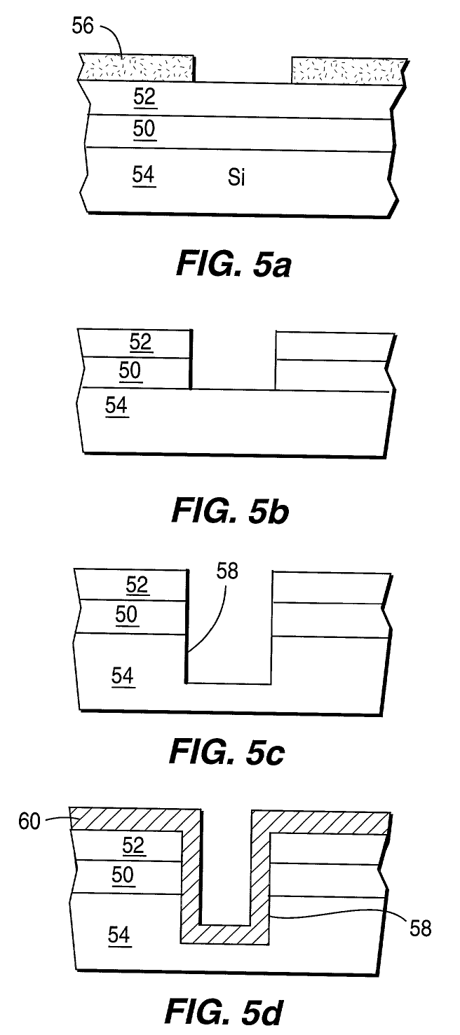

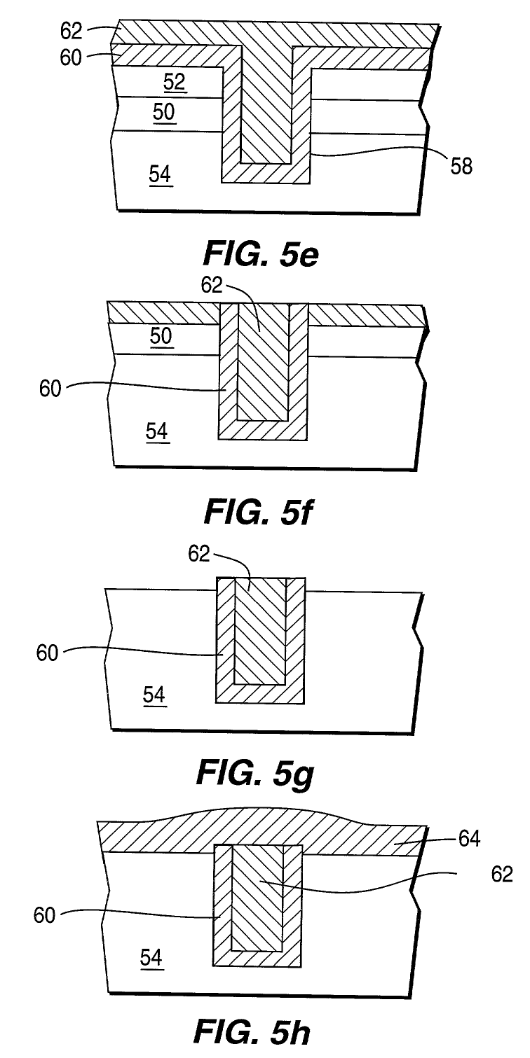

In still another embodiment, a layer of silicon oxide 52 over a layer of silicon nitride 50 is deposited on a silicon substrate 54. A mask layer 56 is deposited over the silicon oxide layer 52, and is patterned, as shown in FIG. 5a.

An opening is etched through the silicon oxide layer 52 and the silicon nitride layer 50, forming a hard mask for the silicon substrate 54. The silicon nitride layer 50 and the silicon oxide layer 52 of the hard mask are then etched down to the silicon substrate 54 as shown in FIG. 5b. An anisotropic opening 58 is etched in the silicon substrate 54, as shown in FIG. 5c.

A bottom cladding layer 60 is then conformally deposited in the opening 58, as shown in FIG. 5d. A core material 62 is then deposited to fill the opening 58, as shown in FIG. 5e. The core material 62 and the silicon oxide layer 52 are planarized, as by CMP, as shown in FIG. 5f. The hard mask (silicon nitride) layer 50 is stripped away, as shown in FIG. 5g. A second or upper cladding layer 64 is then deposited over the substrate, as shown in FIG. 5h.

There are several important advantages of the present invention; the waveguides can be made simply and reliably using standard silicon technology. Silicon can be anisotropically etched readily with fluorocarbons, such as CF₄, in known manner. Further, the silicon oxide and glass-type cladding and core layers can be differently doped so the differences in their refractive index can be maximized. By tailoring the refractive index of the core and cladding layers, loss of light by the waveguide is minimized. The silicon substrate can be used to integrate the present waveguides with other devices and components on the substrate. For example, the use of standard semiconductor processes, such as CVD, halogen etchants, CMP and the like means that conventional processes and equipment can be used to build waveguides and other prior art devices, on the same silicon substrate.

Film stresses in the waveguides are greatly reduced because the present optical waveguides are embedded in a silicon wafer, not deposited in layers which must be patterned and etched. Since the core material is not deposited as a thick layer over a first cladding layer, which core must be etched, but instead deposited in an opening made in the silicon substrate, etching of the core layer is not required.

Further, removing excess core and cladding layers is done by CMP, producing an optically smooth, polished surface. In addition, because the optical waveguides of the invention are formed in a silicon wafer rather than on it, no etching of the core material layer is required. Another advantage is that because the optical waveguide is embedded in a silicon or other wafer, alignment of the waveguide with other devices, particularly optical fibers, is much easier. Optical fibers can be laid in a trench formed in the silicon substrate surface, which can be readily etched and aligned with the waveguide.

The waveguides can also be integrated vertically to other devices formed in the silicon substrate prior to forming the waveguides of the invention.

Although the present invention has been described in terms of particular substrates and layers, the invention is not meant to be limited to the details set forth herein, but is only to be limited by the scope of the appended claims.

We claim:

1. A method of making an optical waveguide in a substrate material comprising
a) forming an opening in said substrate,
b) depositing a first cladding layer conformally in said opening,
c) filling said opening with a core material;
d) removing excess core material, and
e) depositing a second cladding layer over the substrate.

2. A method according to claim 1 wherein said substrate is selected from the group consisting of silicon, silicon-germanium, gallium arsenide, indium gallium arsenide and indium phosphide.

3. A method according to claim 2 wherein said substrate is silicon.

4. A method according to claim 3 wherein said first and second cladding layers are of silicon oxide each having a different refractive index.

5. A method according to claim 1 wherein excess core material is removed by chemical mechanical polishing.

6. A method of making an optical waveguide in a silicon-containing substrate having a layer of silicon nitride and a layer of silicon oxide thereon comprising
a) masking and patterning an opening in said mask,
b) etching through the silicon oxide and silicon nitride layers to form a hard mask,
c) etching an opening in said substrate,
d) conformally depositing a first cladding layer of silicon oxide in said opening,
e) filling said opening with a core material having a different refractive index than said first cladding layer;
f) planarizing the core and first cladding layer to remove said silicon oxide layer,
g) etching said silicon nitride layer, and
h) depositing a second cladding layer having a different refractive index than the core material and the first cladding layer.

7. A method according to claim 6 wherein said substrate is silicon.

8. A method according to claim 6 wherein said substrate is silicon on insulator.
